(19) United States
(12) Patent Application Publication
(10) Pub. No.: US 2012/0133128 A1
(43) Pub. Date: May 31, 2012

(54) CLAMPING SLEEVER AND CLAMP CONNECTION

(76) Inventor: Harald Bohl, Gemunden-Grusen (DE)

(21) Appl. No.: 13/365,866

(22) Filed: Feb. 3, 2012

Related U.S. Application Data
(63) Continuation of application No. 11/885,635, filed on May 28, 2008, now abandoned.

(30) Foreign Application Priority Data
Mar. 7, 2005 (DE) 20 2005 003 812.1

(51) Int. Cl. F16L 21/00

(52) U.S. Cl. 285/322

(57) ABSTRACT

A clamping stub 10—to detachably hold in place elongated construction components 30 at a support 20 which is fitted with at least one continuous, threaded hole 25—comprises a stub shank (12) which can be screwed into said hole and is fitted with an inside space 22 congruent with the component 30 that can be slid into it in close-fit manner. The stub shank 12 comprises an external thread 14 fitted with at least one axis-parallel slit 16. The nominal diameter of the external thread 14 equals that of the threaded hole 25. A head 15 of the stub shank 12 is fitted with shaped surfaces 26 on which a tool may be applied and by its flanged surface 24 exceeds the diameter of said external thread 14. The inside space 22 flaring toward its end 13 in particular in conical manner runs as far as into the head 15 or passes through it. Clamping stubs 10 devoid of a head and of which the shank length at most equals the thickness of the support 20 may be used for a tubular or flat-steel support 20 fitted with at least one continuous, threaded hole 25 subtending an angle to said support. The components to be affixed to said support may be railing bars, tubes/pipes or the like. Double clamping stubs 35 are appropriate for system connection and for further applications such as slide bearings, shaft-hub couplings shaft couplings and the like, wherein the invention offers the pronounced advantage of clamping force adjustability.

The present invention relates to a clamping stub defined in the preamble of claim 1 and to a clamped connection implemented by it as defined in claim 13.

Stubs, bushes, adjusting rings and the like are widely used to clamp for instance cylindrical bars, tubes/pipes and the like, said clamping elements comprising at least one radially inserted adjusting or compression screw. When such a screw is tightened, its end compresses the inserted bar which thereby is forced against the opposite inside wall of the stub or ring. A pressure transmitting element is inserted between the above components to preclude deforming the clamped part, such deformation not only entailing a pressure focus but also being potentially damaging, for instance at a clamped pipe end.

Other clamping connections require several elements, typically at least three, and/or conically mating contours. Illustratively according to the Japanese patent document JP 08312623, it is conventional practice to force a conical, threaded part of a (construction) component in the form of a claw by means of a tightening nut against the bar to be clamped in order to enclose and tighten a round material by means of a split bush. In a similar manner the French patent document FR 1 118 539 A provides a threaded stub fitted with several longitudinal slits and comprising a conically tapering end to allow it being forced into a nut with a mating cone onto a pipe/tube passing through the stub. In the French patent document 2 086 877 A. a longitudinally slatted bush is fitted with an outer thread and with an inside thread only slightly larger than the external diameter of a bar to be clamped by means of two locknuts or mating threads, on said bar. In all of these devices, the part being clamped is clamped radially only over a short length inadequate for high loads. As a result bonding must be used to assure that the clamping be effective not only initially but permanently if unforeseen forces or torques should arise.

One important object of the present invention is to create simple means to clamp in particular elongated parts that in general must be affixed in place permanently, though they also might be displaceable, in supports, joints, tubes/pipes. The goal furthermore is to attain quick and simple connection which optionally may be detachable.

The main features of the present invention are stated in claim 1 and claim 13. Embodiment modes are objects of the claims 2 through 12 and 14 through 23.

A clamping stub to detachably affix a longitudinally elongated and illustratively tubular or bar-shaped component to a support, joist, pipe or the like fitted with a continuous threaded hole comprises a stub shank which can be screwed into said threaded hole, said shank comprising an inside space that is congruent with the component displaceable within it and is characterized in claim 1 by an especially monotonely flaring inside space running from the top to the free end of the stub shank in a manner that its inside width at the free end is larger than the outside dimension of the inserted component and that the clamping stub screwed into the said threaded hole clamps the inserted component circumferentially and around its full length of clamping.

The costs of manufacturing and assembly of this design are unusually low. This economical clamping stub merely need be screwed into the support's threaded hole—absent any additional element—in order to hold the matching component end in the stub shank's inside space. The component typically is cross-sectionally constant along its entire length and can be reliably tightened, though where needed it may be detached easily and without entailing damage either to remove it or exchange it.

In a further advantageous embodiment mode of the present invention, the stub shank is fitted with an external thread and at least one slit running parallel to its axis, i.e. it is axis-parallel. Two or more axis-parallel slits are advantageous, preferably three or four, as a result of which the component to be held in place can be surrounded at its matched end with half shells or by three or more resilient legs. This action being concentric, the component is also automatically centered inside the stub shank and hence the tightening forces are circumferentially equidistant.

The stub shank may be fitted with a head of which the diameter exceeds that of the external thread, resulting in a collar or flange by means of which the clamping stub may rest flush against the support. This feature assures an especially firm and reliable connection. The head moreover may be a cap nut or the like and be fitted at its periphery with flats to be driven by a tool—namely a wrench—so that the clamping stub preferably being handled at its free end can be easily screwed and tightened into the support. Optionally or additionally, the head is fitted at its top side with a transverse slit, with Phillips slits or at least one recess, for instance in the form of a hexagonal blind hole to allow applying a matching screwdriver.

Preferably the stub shank inside space runs as far as into the said head. In this manner the end of the component may be clamped over the greatest length possible. Moreover, without trading weight for mechanical strength, the clamping stub's weight still can be minimized. Alternatively the stub shank inside space may continue through the head at the same or a lesser diameter. In the through-hole so formed and if desired, the upper end of the component to be fixed in place may project upwards through the continuous hole so formed in a manner advantageous for instance for multilevel wire containers.

In another advantageous embodiment mode of the present invention, the stub shank may be fitted with or at least partly constitute a screw nut. This design excluding a stub head, the clamping stub may be sunk until disappearing into a desired depth inside a more substantial support. The thread aperture may be externally terminated for instance by a fake closure, a decorative cap or the like, preferably being flush. Again, and even when the stub shank is fitted with a stub screw or constitutes such at least in part, it is possible to additionally constitute an internal screw connection with the component to be held in place or within this component.

The clamping stub's recess or inside tightening screw preferably uniformly flaring toward the stub shank's free end, its inside width at said free end exceeds the outer dimension of the component which as a result may be easily inserted even if there is little play. Starting at its free end, the stub shank is slitted longitudinally whereby its legs rest on the part to be clamped as if they were resilient tabs. As the clamping stub is screwed into the support until coming to rest surface against surface, the stub shank is being elongated because the thread flanks of the inner and external threads, that is of the clamping stub and the threaded hole, act as oblique planes against each other. Due to the force so generated at the thread flanks, the shank legs deform inward, their terminal inside diameter being reduced, and the recess henceforth runs in smoothly cylindrical manner. As a result the inserted component is gripped by the full length of the clamping stub.

This clamping stub action may be attained using any kind of thread and with typical thread tolerances; the external thread need not be oversized relative to the threaded holes. Instead there may even be a thread play for instance of a few tenths of a mm. The designed wedging effect of the thread causes the tightening force and if the external thread is of high pitch, then the ensuing force transmission produces a high wedging effect. Reversely considerable tightening play shall be attained if the external thread is low-pitch. Further parameters are the clamping stub's wall thickness, its elasticity and the number and width of the axial slits separating the stub legs from one another.

As defined by claim 13, which is independent, the present invention moreover relates to a clamping stub fitted with a support, for instance a tubular or a sheet steel support fitted with at least one threaded hole to implement connection to a support by screwing into it a clamping stub of the above kind holding a tubular or bar-shaped component. The direction of the and/or each hole in the support determines the orientation of the and/or each component held in place. Because of the great convenience offered by the present invention, very short assembly times are possible. Advantageously the stub shank length at most is equal to the thickness of the tube or the flat steel support, precluding the free end of the clamping stub from protruding, thereby offering good esthetics and easy cleaning. A the same danger of injury is averted.

In a preferred design of the clamping connection, the tube or the flat steel support is fitted with a number of equidistant threaded holes. This design may be applied especially advantageously in (stair and the like) railings of which the banisters or upper parts are fitted with parallel, downward-running tubular or bar-shaped components. The upper component ends are seated in the clamping stubs which are screwed into the banisters or upper parts. The railing bars or tubes/pipes can be assembled by means of the clamping stubs at an angle, in particular a right angle to the upper part which generally is a banister in the form of a tubular or flat steel support. This support may be borne by the bars, tubes/pipes and the like anchored in a foundation, or also by edge-side posts. Such railings are part of the present invention.

In a further development of the present invention, the clamping stub may be screwed to the inner thread of a coupling nut, as a result of which a straight or angled bar or tube/pipe connection may be set up. A double clamping stub is applicable in especially advantageous manner in this respect, where the two clamping stubs are integrally joined to each other by a central or angled part. Sealing rings are used in the double clamping stub to connect tubular elements; a washer may be inserted between an external sealing ring and the clamping stub end to preclude forcing the shank leg ends into the sealing ring.

The adjustability of the clamping force is especially advantageous when using clamping stubs in slide bearings, shaft couplings and the like. As regards a shaft-hub coupling, it suffices to screw a clamping stub acting as a hub into the central borehole of a gear in order to affix a shaft in its recess.

Further features, particular and advantages of the present invention are found in the wording of the claims, also in the following description of illustrative embodiment modes in relation to the appended drawings.

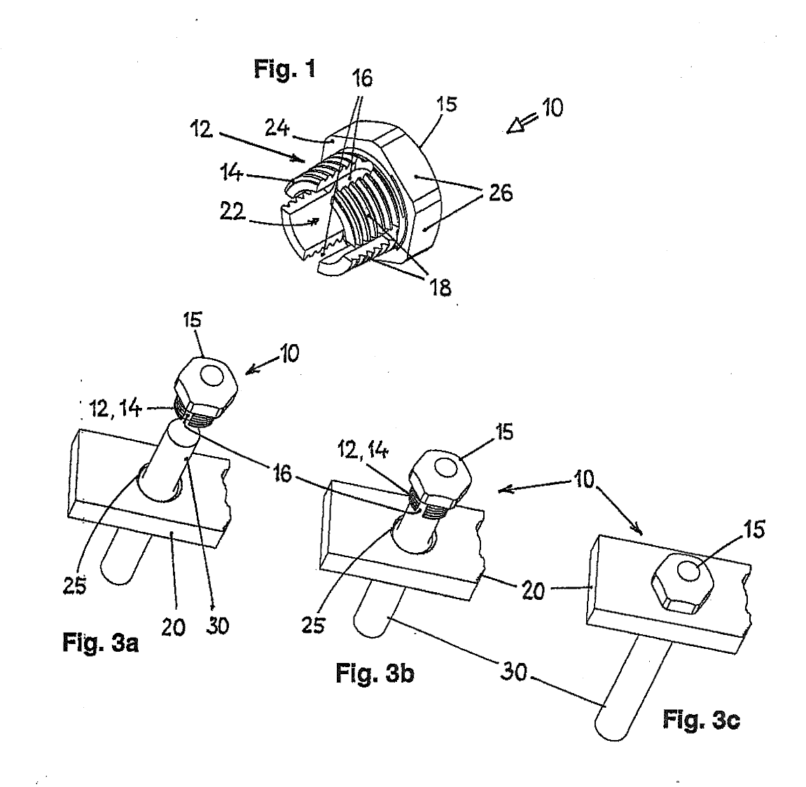

FIG. 1 is an oblique perspective—seen from below—of a clamping stub of the invention,

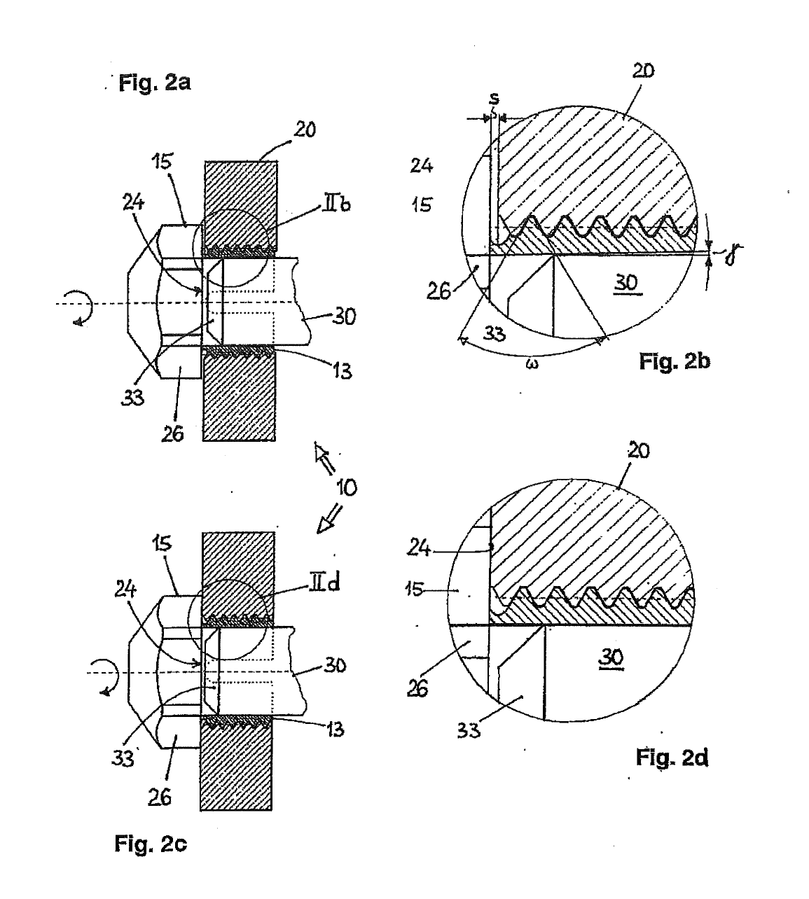

FIG. 2a is a sideview of a clamping stub showing an axial sideview of a support and a partly inserted component,

FIG. 2b is an enlarged partial view corresponding to the circle IIb of FIG. 2a,

FIG. 2c is a sideview as in FIG. 2a, however showing a surface-to-surface rest against the support,

FIG. 2d is an enlarged partial view corresponding to the circle 11d of FIG. 2c,

FIGS. 3a, 3b 3c each show an oblique view of a clamping stub with the support and component in various positions,

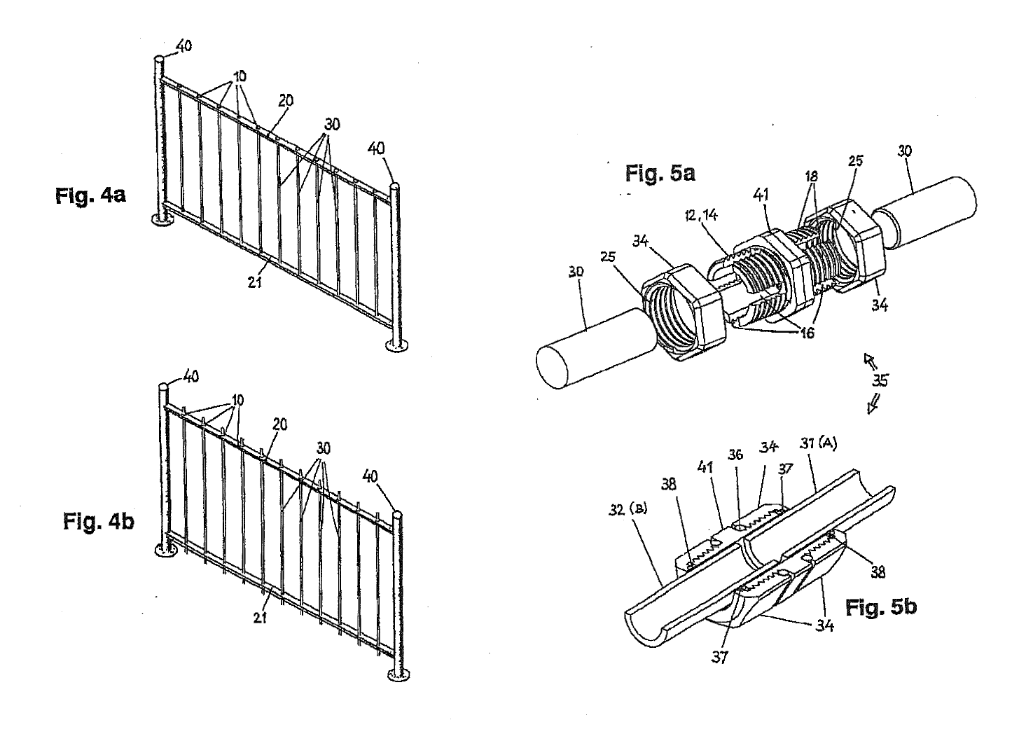

FIG. 4a is an oblique view of a railing fitted with the clamping stubs of the invention,

FIG. 4b is an oblique view of a railing similar to that of FIG. 4a,

FIG. 5a is an exploded oblique view of a double clamping stub and of components to be clamped,

FIG. 5b is a half oblique view of the assembled components of FIG. 5a,

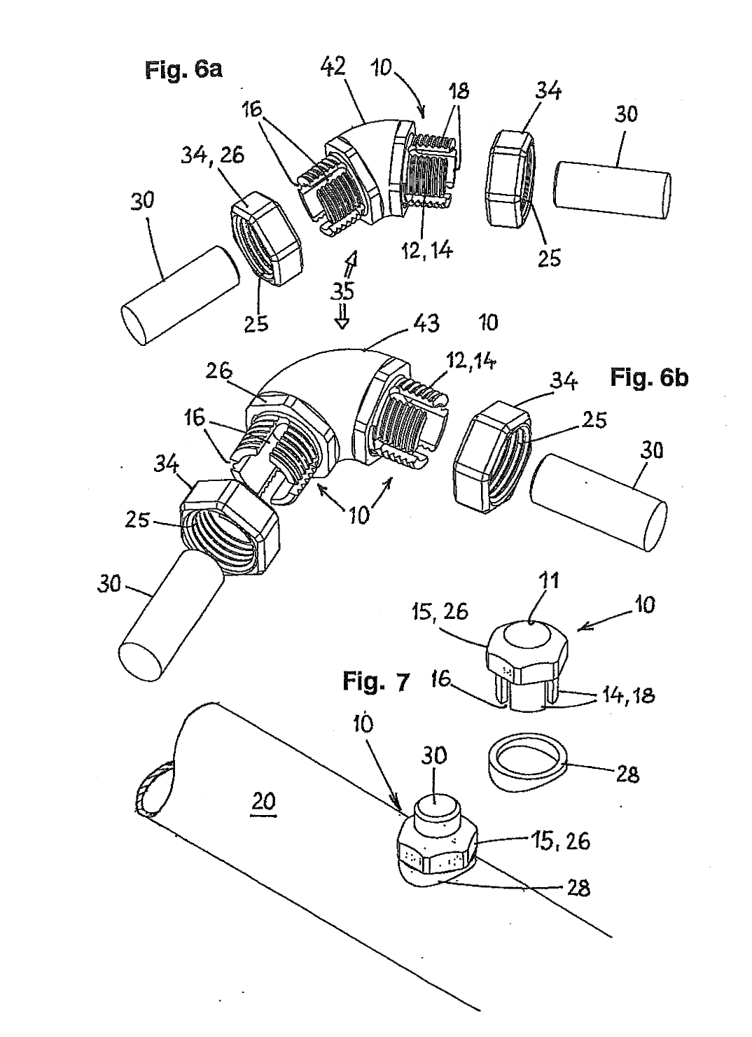

FIG. 6a is an exploded oblique view of an angled double clamping stub and of the components to be clamped,

FIG. 6b is a view similar to FIG. 6a, however for a modified design,

FIG. 7 is an oblique view of a clamping stub and of a spacer ring before and after assembly to a pipe,

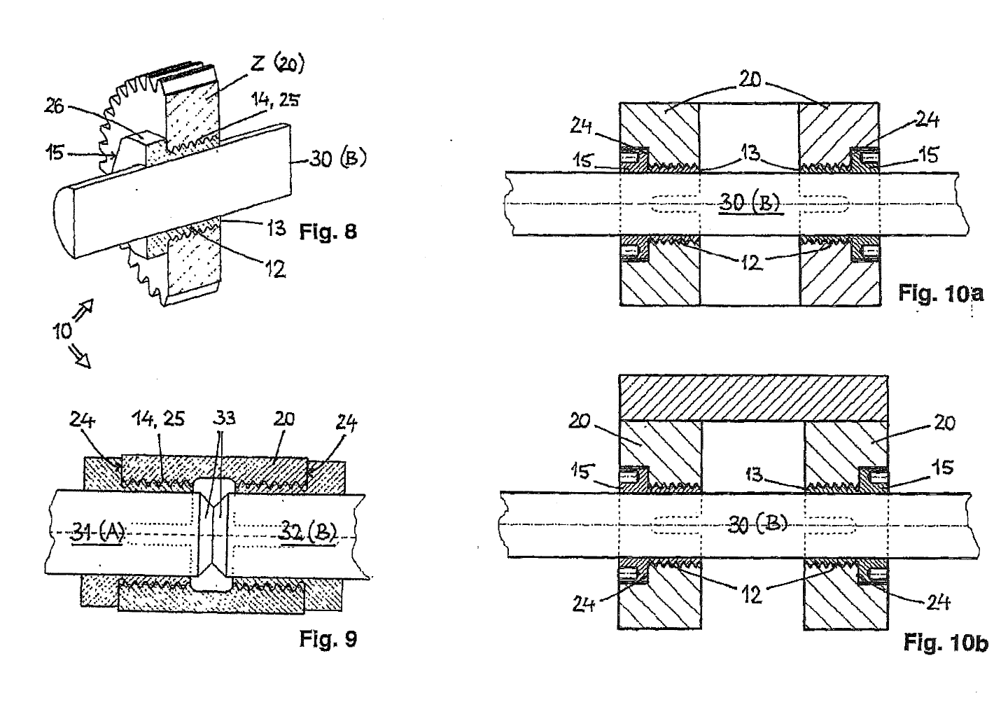

FIG. 8 is an oblique view, partly in axial section, of a shaft-hub connection,

FIG. 9 is an axial section elevation of a shaft coupling, and

FIGS. 10a and 10b each are an axial section elevation of two slide bearing bushes.

FIG. 1 shows the design of a clamping stub 10. It is like a chuck. A stub shank 12 is fitted with an external thread 14 and comprises (in the shown embodiment mode) a head 15 projecting beyond the shank diameter and subtending relative to the shank 12 a collar or a flanged surface 24. Axis-parallel slits 16 run from the free end 13 of the shank toward the head 15 and divide the external thread 14 into segments, hereafter legs, for instance into four stub legs 18.

The stub shank 12 encloses a clear inside space 22, which extends into the head 15. To screw the clamping stub 10 into its position, the head 15 is fitted with flats, for instance screwing flats 26 which may be driven for instance by a mechanical wrench. Alternatively the end face of the head 15 may be fitted with a screwdriver slot, straight or Phillips, or also at least one recess allowing insertion of an appropriate tool.

A component 30 to be seated by sliding may be fitted into the inside space 22, the respective contours as well as the dimensions of the inside space 22 and of the component 30 being matched to each other. The inside space 22 flares from the head 15 toward the end 13 of the stub shank 12 and thereby facilitates inserting this component 30 which in general has a uniform cross-section over its entire length. The length of the inside space 22 being larger at the free end 13 than the outside dimension 39 of the inserted component 30, the clamping stub 10—which when being screwed into the threaded hole 25 will be elongated and thereby tightened—shall enclose the inserted component 30 by its full clamping length as shall be elucidated below in relation to FIGS. 2a-d.

In actual operation, the clamping stub 10 may be inserted for instance from above or below into a (flat) support 20. A tube/pipe or bar-shaped segment 30 to be clamped in place is inserted through the threaded hole 25 of the support 20 (FIG. 3a) and then the clamping stub 10 is set on said support in a manner that the upper end of the component 30 shall dip as deeply as possible into the inside space 22 of stub clamp 12. Thereupon the clamping stub 10 is screwed into the threaded hole 25 (FIG. 3b) wherein it is tightened using an appropriate tool, for instance a mechanical wrench or a double-headed wrench until the collar or flange 24 tightly abuts the support 20 (FIG. 3c).

In its position shown in FIGS. 2a and 2b, the clamping stub 10 has not been fully screwed into the support 20, which may be a flat steel element, as a result of which a gap s remains between the flange surface 24 and the surface of the support 20 opposite it. As yet the clamping stub 10 is in its unstressed state and the conicity of the inside space 22 is denoted by the wedge angle γ (FIG. 2b) subtended with the surface of the component 30. At its front end, the component 30 is fitted with a bevel 33 to further facilitate inserting the component 30 into the clamping stub head 15.

Once the component 30 has reached its desired position, affixation is implemented by fully screwing the clamping stub 10 into the threaded hole 25 until the collar or flange 24 of the head 15 rests hard against the opposite surface of the support 20 (FIGS. 2c, 2d). FIG. 2d shows that the wedging effect of the threads has compressed concentrically the lower, i.e. the inner end of the stub shank 12 as the said clamping stub was screwed into the threaded hole 25, such concentric compression being feasible due to the axis-parallel slits 16. In the process the gap “s” vanished to zero and the screw's force tightened the stub shank 12 whereby its legs 18 now tightly rest over their entire clamping length on and around the full surface of the component 30.

Appropriately the thread diameters and the mechanical fits, i.e. the fit plays, are so matched to each other that the clamping force assures firm seating devoid of any plastic deformation of or even damage to the clamped segment 30. This goal already is attained by the nominal diameter of the external thread 14 being the same as that of the inside thread 25 at the support 20. By means of the shape of the thread 14 and its dimension, further a notch radius at the head/thread set, the stub wall thickness and the number and width of the slits 16, both the clamping force and the clamping path can be controlled as needed. The thread pitch matters considerably: a high-pitch thread allows and entails a large clamping force. A low-pitch thread allows much latitude in clamping.

FIGS. 4a and 4b show a practical application. In the embodiment mode of FIG. 4a, two posts 40 brace a support 20 holding a set of bars 30 in a parallel position in clamping stubs 10. These clamping studs are affixed in the lower end of a second support 21 also affixed to the posts 40. FIG. 4b is a modified embodiment mode of such a railing, wherein the clamping stubs 10 are traversed by the upper ends of the bars 30 and in this manner project above the support 20. In matching manner, the lower ends of the bars 30 project downward from the second support 21 ands preferably to the same extent as above the support 20.

In an embodiment variation shown in FIGS. 5a and 5b, two clamping stubs 10 are coaxially joined at their heads at the middle part 41 of a double clamping stub 35. Inserted components 30 are clamped by coupling rings 34 of which the inner threads 25 concentrically and circumferentially tighten the slitted stub shank 12. If the components are pipes 31, 32 passing fluid media, then sealing rings 36 are appropriately inserted at the double stub 35 and further sealing rings 37 are inserted into the coupling rings 34. To prevent these sealing rings 37 from being forced into the shank slits 16, a washer 38 rests in each stub end.

As shown by FIGS. 6a and 6b, such double clamping stubs 35 also may be angled and for that purpose be mounted on each side at an angle part 42 respectively 43. FIG. 6 shows an obtuse design of the angle part 42 whereas FIG. 6b shows a right-angle part 43. In both cases the double clamping stub is appropriate to connect solid or hollow components 30, preferably bars or tubes/pipes.

Appropriately the clamping stub 10 mounted to tubular supports in a manner that a spacer 28 having a planar outer surface and an inner concave surface (FIG. 7) shall be placed between the tubular support 20 and the clamping stub 10, the said concave inner surface matching the radius of curvature of the tubular support 20.

FIG. 8 shows a shaft/hub connection where the clamping stub 10 acts by means of its shank 12 as a hub being screwed into the schematically shown gear Z that only requires a centered threaded hole 25. The shaft B need not be processed; it may be positioned and affixed in an arbitrary zone within the stub 10. The clamping force may be adjusted highly advantageously by means of the tightening torque of the stub 10 in that the adjustability of the torque to be transmitted simultaneously may be used as an overload protection feature.

FIG. 9 shows a frictionally clamping shaft connection. In this case the support 20 is a threaded bush each end of which admits an initially screwed-in a clamping stub 10, whereupon one shaft each 31/A respectively 32/B is inserted and the stubs 10 are firmly tightened so that their heads 15 each rest by their contacting surface against the associated end face of the threaded bush 20. The applied tightening torque determines the transmissible load torque and again overload protection is intrinsically assured. In the extreme, the shafts may slide in the (or each) clamping stub 10 without jeopardy to other machine parts.

FIGS. 10a and 10b show another application of the internal tightening screw. To implement linear sliding guidance, two clamping stubs 10 are used as sliding bearing bushes made of a slide bearing polymer or a slide bearing brass and fitted in the head 15 with endside blind holes accessed by an omitted tool. The free ends 13 of the clamping stubs 10 are configured opposite each other. The supports 20 may be connected independently (FIG. 10a) or rigidly to each other (FIG. 10b). Merely by tightening the (or each) thread connection, the guidance play may be adjusted to actual need. This feature is advantageous compared with the state of the art wherein the slide bearing bushes either display a predetermined play relative to the guide shaft or they are playless due to immutable prestressing.

The invention is not restricted to the above discussed embodiment modes, instead it may be modified in many ways. Illustratively the support 20 also may act as a nut or coupling ring 34—that may be slitted—into which the clamping stub 10 shall be screwed, the stub shank 12 preferably being beveled at the free end and fitted with slits 16 of which the number and width are selectable. Also the inside space 22 and the component 30 may be cross-sectionally and identically contoured, for instance in tetragonal or polygonal ways; illustratively polygonal bars may be received in clamping stubs 10 comprising the same polygonal inside space.

In summary, a clamping stub 10 of the invention detachably holding for instance a tube/pipe or a bar-shaped component 30 and being mounted in a support 20 fitted with at least one continuous, threaded hole 25, comprises a stub shank 12 which can be screwed into said threaded hole and is fitted with an inside space 22 congruent with the component 30 and which can receive and seat said component being slid into it. The stub shank 12 is fitted with an external thread 14 comprising at least one axis-parallel slit 16, preferably comprising three or four slits. The nominal diameter of the external thread 14 is the same as that of the threaded hole 25. A head 15 of the stub shank 12 may extend by its flange surface 24 beyond the diameter of the external thread 14. At its periphery, the head 15 may be fitted with shaped surfaces (26) to be driven by a tool. The inside space 22 flaring in particular conically toward the free end 13 runs as far as into the head 15 or it passes through it at the same or a reduced diameter. Regarding a clamping connection involving a tube/pipe or flat steel support 20 comprising at least one angle-subtending, continuous threaded hole 25, clamping stubs 10 devoid of heads may be used, their stub shank length at most equaling the thickness of the tube/pipe respectively of the flat steel support. The components 30 to be affixed may be (for instance stair or other) railing bars that can be assembled by means of the clamping stub 10 in particular at right angles to the tube/pipe or flat steel support 20. Double clamping stubs 35 may run coaxially or be angled and are suitable for connecting bar-shaped or tubular components into a system. The adjustability of the clamping force is especially advantageous also for further applications such as slide bearings, shaft-hub connections, shaft couplings and the like.

All features and advantages explicit and implicit in the claims, including design details, spatial configurations and procedural steps, may be considered part of the invention whether per se or in various combinations.

1. A clamping stub (10) to be detachably affixed to a longitudinally elongated construction component (30) of constant cross-section, for instance a tube/pipe, bar or the like mounted in a support (20) comprising at least one continuous threaded hole (25), said support being for instance a joist, tube-pipe or the like, said clamping stub comprising at least one stub head (15) of which the diameter extends beyond the diameter of an adjoining stub shank (12) adjoining said head, said shank being fitted with an external thread (14) meshing with the threaded hole (25) and with at least one axis-parallel slit (18) and subtending an inside space (22) that may receive the congruent component (30) slid into it for clamping,
characterized
by the inside space (22) of the stub shank (12) monotonely flaring from the head (15) of said shank to its free end (13) in a manner that the width of said inside space is larger at its free end (13) than the outer dimension of the inserted component (30) and in that the clamping stub (10) screwed into the threaded hole (25) peripherally clamps the inserted component (30) along said stub's entire clamping length.

2. Clamping stub as claimed in claim 1, characterized in that the inside space (22) flares in conical or curved manner.

3. Clamping stub as claimed in claim 1, characterized the stub shank (12) comprises two or more axis-parallel slits (16), preferably three or four.

4. Clamping stub as claimed in claim 1, characterized in that the head (15) is designed like a cap nut fitted at its periphery with flats (26) at which a tool shall be applied.

5. Clamping stub as claimed in claim 1, characterized in that the head (15) is fitted at its end face with a transverse slot, a Phillips slot or with an inner polygonal recess.

6. Clamping stub as claimed in claim 1, characterized in that the head (15) is fitted with a central aperture (17) axially receiving the component (30).

7. Clamping stub as claimed in claim 6, characterized in that the inside space (22) is in the form of a blind hole running as far as into the head (15) or in the form of a feedthrough hole (17).

8. Clamping stub as claimed in claim 6, characterized in that the inside space (22) passes through the head (15) at a constant or reduced diameter.

9. Clamping stub as claimed in claim 1, characterized in that the stub shank (12) comprises or at least partly constitutes a (screw) nut.

10. Clamping stub as claimed in claim 1, characterized in that the stub shank (12) contains or at least partly constitutes a stub screw.

11. Clamping stub as claimed in claim 1, characterized in that the external thread (14) is a high-pitch thread.

12. Clamping stub as claimed in claim 1, characterized in that the external thread (14) is a low-pitch thread.

13. A clamping connection to a support, in particular a tubular or flat-steel support (20) fitted with at least one continuous, threaded hole (25) that subtends an acute or right angle with said support and used for screw-assembly with a clamping stub (10) defined in claim 1 holding for instance a tubular or bar-shaped component (30).

14. A clamping connection as claimed in claim 13, characterized in that the stub shank length of the clamping stub (10) at most is equal to the thickness of the tube/pipe or flat steel support (20).

15. Clamping connection as claimed in claim 13, characterized in that the tube/pipe or flat-steel support (20) is fitted with a number of equidistant continuous, threaded holes (25).

16. Clamping connection as claimed in claim 13, characterized in that the (or each) component (30) to be affixed is a railing bar which can be assembled by means of the clamping stub (10) at an angle, in particular at a right angle, to the tube/pipe or flat steel support (20).

17. Clamping connection as claimed in claim 13, characterized in that the clamping stub (10) can be screwed into the inside thread (26) of a coupling ring (34).

18. Clamping connection as claimed in claim 13, characterized by a double clamping stub (35) where the two clamping stubs (10) are integrally connected at their heads by a middle or angled part (41; 42, 43).

19. Clamping connection as claimed in claim 18, characterized in that sealing rings (36, 37) serve to connect tube/pipe components (31, 32) at or in the double clamping stub (35).

20. Clamping connection as claimed in claim 19, characterized in that a washer (38) is inserted between an outer sealing ring (37) and the stub shank end.

21. Clamping connection between as claimed in claim 13, characterized in that the clamping stub (10) enclosing a shaft (B) can be inserted by its stub shank (12) acting as a hub into a central threaded aperture (25) of a disk, a gear (Z) or the like.

22. Clamping connection as claimed in claim 13, characterized in that a threaded bush (20) is used for shaft coupling and that a clamping stub (10) can be screwed into each of said bush's open ends and each encloses and affixes a shaft (31/A respectively 31/B) as soon as such a clamping stub's head (15) rests against the associated end face of the threaded bush (20).

23. Clamping connection as claimed in claim 13, characterized in that two end-on-end configured clamping stubs (10) can be screwed into mutually aligned and abutting supports (20).
